(19) United States
(12) Patent Application Publication
(10) Pub. No.: US 2004/0105736 A1
(43) Pub. Date: Jun. 3, 2004

(54) Method and an apparatus for removing pieces of cloth from a pile

(76) Inventor: Steen Nielsen, Ronne (DK)

Correspondence Address: Finnegan Henderson Farabow, Garrett & Dunner, 1300 I Street NW, Washington, DC, 20005-3315, US

(21) Appl. No.: 10/472,241

(22) PCT Filed: Mar. 20, 2002
(86) PCT No.: PCT/DK02/00184

(30) Foreign Application Priority Data
Mar. 22, 2001 (DK) PA 2001 00475

(51) Int. Cl. B08B 1/00

(52) U.S. Cl. 414/13

(57) ABSTRACT

The invention relates to an apparatus for picking out laundry articles from a pile of laundry articles that are arranged in a transportable container that is upwardly open and has a downwardly configured bottom, from where lateral ledges extend upwards to the container opening, which apparatus comprises a frame on which a pull gripper is configured, and means for conveying the pull gripper down into the container opening to a lower position with a view to seizing one or more laundry articles, and subsequently to convey the pull gripper upwards above the container opening with a view to letting go of the seized laundry articles, and wherein the apparatus further comprises means for moving the pile of laundry articles located in the container in a direction towards the lower position of the pull gripper. The invention is characterised in that the means for moving the pile of laundry articles comprise means for positioning the container in relation to the lower position of the pull gripper, and means for lifting the one side of the container in such a manner that the container bottom and at least one of the lateral ledges of the container form a pair of side faces that inclined relative to the horizontal and converge to meet essentially vertically underneath the lower position of the pull gripper and thereby allow laundry articles in the container to successively slide underneath the pull gripper in pace with the pull gripper picking out laundry articles from the pile of laundry articles.

The present invention relates to a method and an apparatus for picking out laundry articles from a laundry pile located in a transportable container that is upwardly open and has a downwardly configured bottom, from where lateral ledges extend upwards towards the opening of the container, which apparatus comprises a pull gripper, and means for conveying the pull gripper down into the opening of the container for a lower position with a view to seizing one or more laundry articles and subsequently conveying the pull gripper upwards above the opening of the container with a view to letting go of the laundry articles thus seized, and wherein the apparatus further comprises means for moving the pile of laundry articles located in the container in a direction towards the lower position of the pull gripper.

Such apparatuses are known today for use in industrial laundries, where the laundry articles, such as bed linen and tablecloths—after having been eg laundered and dried—are in a more or less tangled pile in slightly moist state.

These laundry articles are subsequently to be introduced individually into machines that are configured eg for straightening, ironing and folding the laundry articles.

Thus, in the laundries a certain effort is made with a view to separating the individual laundry articles from the pile in which they are located after laundering and drying, to enable them to be introduced individually in said machines for straightening, ironing and folding.

Today, machines are known that are able to perform this process partially automatically, whereby the cumbersome task of pulling out the individual. laundry articles from the pile is performed automatically.

WO patent application No. 97/13914 and U.S. Pat. No. 4,943,198 thus disclose apparatuses wherein the laundry articles are located in a stationary container intended therefor, and wherein, above this container, a pull gripper is located that can be raised and lowered relative to the container, whereby the pull gripper is able to seize one or more laundry articles in its lower position, and subsequently lift them clear above the container. It is subsequently possible to lay down the laundry article picked out and transport it away from the laundry pile to the subsequent treatment.

In order to ensure to the widest extent possible that the pull gripper seizes one of the laundry articles located in the container, a conveyor is configured in the two above-mentioned cases that constitutes the bottom of the container, whereby the pile of laundry articles can successively be moved to the lower position of the pull gripper, whereby the latter will essentially always seize one of the laundry articles in the container.

However, it is a problem with the above-mentioned apparatuses that in most laundries, for the sake of the laundering and drying machinery as such being located at a considerable distance from the machines that carry out the subsequent treatment of the laundry articles, container wagons are- used that are provided with wheels and can thus easily be charged with a pile of the finished laundered and dried laundry articles and are subsequently taken to one of said pick-out apparatuses, where the container wagons are to be emptied into the stationary containers provided with conveyors, following which it. is possible to pick out individual laundry articles from the pile as mentioned above.

This problem is remedied by the prior art taught by EP patent No. 971,062 disclosing a system for taking out laundry articles from a transportable container, which container can be shifted forwards and backwards underneath the pull gripper. When the pull gripper thus attempts in vain to seize a laundry article in a pull-out cycle, the apparatus comprises means that ensure that the container wagon well always be moved. a distance whereby the chance of seizing a laundry article is increased, the pull gripper seizing elsewhere in the container.

In the light of this, it is the object of the present invention to provide an apparatus of the kind disclosed above for picking out laundry articles from a pile of such located on a container, said apparatus distinguishing itself over the prior art by being relatively simple from a constructive point of view, and whereby, on the one hand, it is obtained that the pile of laundry articles is not to be discharged from the transportable container wagons until it can be removed piece-by-piece from the laundry pile. by the pull gripper, and on the other hand it is avoided to the largest extent possible that the pull gripper performs a gripping cycle in vain.

This is obtained by the present invention by a method and an apparatus of the kind described above, and wherein the method and the apparatus is characterised in that the means for moving the pile of laundry articles comprises means for securing the container relative to the lower position of the pull gripper, and means for lifting the one side of the container in such a manner that the container bottom and at least one of the lateral ledges of the container form(s) sliding faces that meet essentially vertically underneath the lower position of the pull gripper, and thereby successively allows laundry articles in the container to slide underneath the pull gripper as the pull gripper picks out laundry articles from the laundry pile.

Hereby it is possible to take out laundry articles directly from the transportable container wagon, while simultaneously the slide faces ensure to a high degree that there will always be a laundry article at the lower position. of the pull gripper, for as long as there are laundry articles present in the container, which yet again means that it is not necessary to establish means for recording and moving the container in pace with it being emptied by the pull gripper.

According to a particularly advantageous embodiment the container is provided with wheels, and the means for securing and lifting the container is constituted by a ramp located underneath the pull gripper, said ramp being configured such that the wheels of the container can be driven onto the ramp, and wherein the ramp has a first end that is located relatively close to the lower position, of the pull gripper, and a second end that is located relatively further away from the lower position of the pull gripper, wherein at least one actuator is configured that is configured with a view to lifting the second end of the ramp relative to the first end of the ramp, and wherein the apparatus comprises means for securing the container on the ramp. Hereby it is obtained that the apparatus is able to work even if container wagons of different sizes are used. This is particularly advantageous, since it is hereby possible to introduce the apparatus to already existing laundries without this involving that that it is necessary to replace all the container wagons already being used in the relevant laundry.

According to a particularly simple embodiment, the ramp is at its first end provided with a gable that prevents the container from rolling beyond this end of the ramp, and wherein the opposite end is configured with a chute that is configured such that it allows the container to unimpeded drive onto the ramp.

The above-mentioned movement can also be established in a very simple manner by the ramp being, at its first end, pivotally secured to the frame of the apparatus.

Most advantageously the apparatus is configured for lifting the bottom of the container upwards to an angle relative to the horizontal plane, which angle is between 30 and 60 degrees. This is due to the fact that, within this angle range, it is obtained that most existing container wagons will function reasonably within this angle range.

Particularly advantageously, however, the apparatus comprises means for adjusting the angle of the bottom as desired relative to the horizontal when the bottom is lifted, whereby the angle can thus be optimised with a view to obtaining a suitably efficient movement of the laundry pile within the container, irrespective of the size and nature of the container used.

If the container used in the apparatus is configured of a material that forms high friction in relation to the laundry articles, eg if the container is made of canvas, means are advantageously provided with a view to shaking or vibrating the container in the position in which the one end of the container has been lifted.

This latter vibration may, according to a preferred embodiment of the invention, be established provided the actuator established for lifting the container is configured for also being able to generate vibrations in the ramp and thus in the container.

By a further preferred embodiment of the invention the apparatus comprises a lower conveyor which is arranged in such a manner that the one end of the conveyor extends underneath the lateral ledge that serves as a slide face for the laundry articles when the one side of the container has been lifted, and by the upper position of the pull gripper being located above the lower conveyor, and wherein the lower conveyor is configured with a view to transporting the laundry articles in a direction away from the container. Thereby laundry articles that are seized by the pull gripper as well as laundry articles that merely drop across the capsized lateral ledge can be captured by the conveyor, whereby no laundry articles drop to the floor or escape the continued treatment process in the laundry.

In order to ensure that so many laundry articles can be transferred simultaneously to the subsequent process equipment in the laundry, the apparatus according to the invention advantageously comprises an upper conveyor located above the lower conveyor, which is also located underneath the upper position of the pull gripper, and they are configured for transporting the laundry articles away from the container.

The invention will now be described in a preferred embodiment with reference to the drawing, wherein

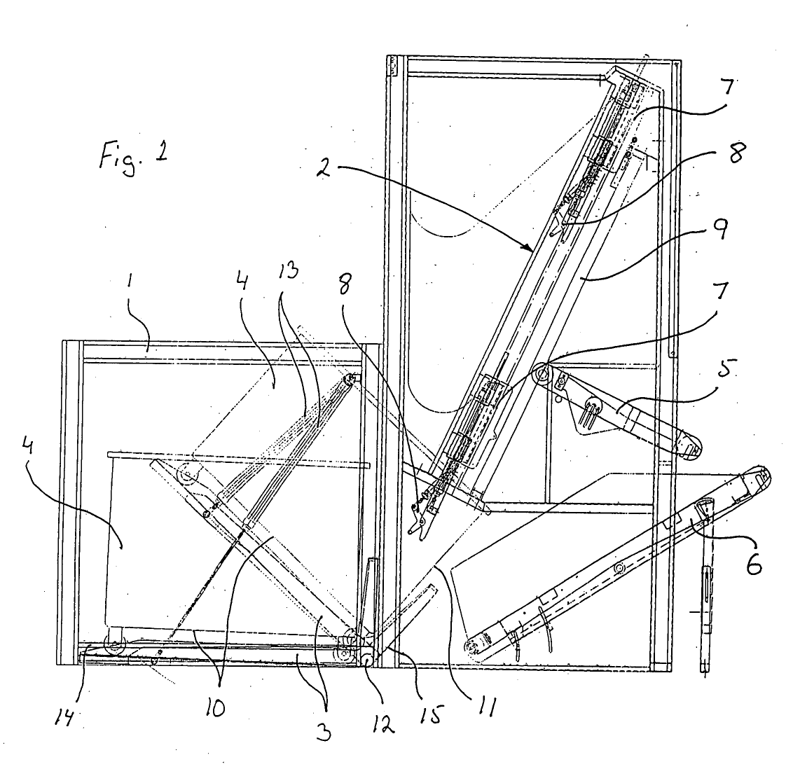

FIG. 1 is an explanatory sketch of an apparatus according to the invention, seen from the side and with a container wagon located therein;

Thus, FIG. 1 shows an apparatus according to the present invention, which apparatus comprises a frame 1 in which a pull gripper 2 is located; a ramp 3 with a container wagon 4 arranged thereon. Besides, the apparatus comprises a conveyor arrangement consisting of an upper conveyor 5 and a lower conveyor 6.

The pull gripper shown in the figure comprises one single gripper arrangement, as shown in the figure in an upper A and a lower B position, respectively. This gripper arrangement thus consists of a sledge 7 on which a gripper 8 is mounted, and wherein the sledge 7 can be displaced along a rail 9 by means of a not shown actuator between the upper A and the lower B position.

Underneath the pull gripper the ramp 3 is located, and in the shown scenario a container wagon 4 is located on the ramp. Thus, the ramp is shown in a situation where the container wagon located on the ramp has capsized about 40° relative to horizontal, whereby the bottom 10 of the container and the one of the sides 11 of the container form two mutually and downwardly converging slide faces that allow laundry articles in the container wagon to slide downwards in that end of the bottom that is located substantially right below the lower position B of the pull gripper 8, whereby the pull gripper 8 can easily be caused to easily seize one or more laundry articles from the laundry pile located at the bottom of the container 4, and lift the laundry article out of the container 4 and upwards to the upper position A of the pull gripper 8, where the pull gripper may let go of the laundry article which will thereby drop onto one of the conveyors 5,6 which is configured with a view to transporting the laundry article away from the container.

According to the preferred embodiment of the present invention the ramp is mounted such that it can be turned about a horizontal axis 12 at the lower end of the ramp 3 that is most proximate to the lower position B of the pull gripper. This turning movement is activated by means of an actuator 13 that can, as shown, be constituted of a linear actuator that is, at its one end, secured to the frame 1 of the apparatus, and at the other end is secured to the ramp 3 a distance away from its axis of rotation 12. Thereby the ramp 3 can be moved between a lower position in which the ramp 3 is essentially parallel with the horizontal frame portion 14, and an upper position in which the ramp 3 has an angle of about 40° relative to the horizontal.

As will appear the ramp is, at the end that is most proximate to the lower position of the pull gripper 8, provided with a gable 15 that prevents the container 4 from rolling off the ramp 3 in the shown position, and at the opposite end a chute is configured that allows the container to be rolled effortlessly up the ramp.

According to a preferred embodiment the shown actuator 13 is configured such that it is able to apply vibrations or tremors to the ramp 3 in the shown position. Thereby laundry articles that do not, eg as a consequence of friction between the laundry article and the container, by themselves slide down the container 4 bottom can yet be caused to do so in a simple manner. The means that are necessary for providing this vibration or tremor and the means needed to drive the actuator are, for the sake of overview, not shown since the person skilled in the art is able to readily suggest embodiments thereof on the basis of this specification.

It will further appear from the figure that two conveyors 5,6 are provided, viz an upper conveyor 5 and a lower one 6. As mentioned above, these conveyors 5,6 serve to convey laundry articles away from the container 4 by the upper conveyor 5 capturing the laundry articles that are released from the pull gripper 8 in the upper position A thereof, and in case laundry articles drop across the lateral ledge or the gable 11 of the container 4, they will be captured by the lower conveyor 6. Thereby it is obtained that the laundry articles are separated to the widest possible extent, while simultaneously, laundry articles that are not seized and fall beyond the edge of the container 4 will be included in the subsequent treatment process in the laundry.

1. An apparatus for picking out laundry articles from a pile of laundry articles that are located in a transportable container that is upwardly open and has a downwardly configured bottom, from where lateral ledges extend upwards to the container opening, said apparatus comprising a frame, on which a pull gripper is configured, and means for conveying the pull gripper down into the opening of the container to a lower position with a view to seizing one or more laundry articles, and subsequently conveying the pull gripper upwards above the opening of the container with a view to letting go of the seized laundry articles, and wherein the apparatus further comprises means for moving the pile of laundry articles located in the container in a direction towards the lower position of the pull gripper, characterised in that the means for moving the pile of laundry articles comprises means for positioning the container relative to the lower position of the pull gripper, and means for lifting the one side of the container in such a manner that the container bottom and at least one of the lateral ledges of the container form a pair of slide faces that are inclined relative to the horizontal, that converge to meet essentially vertically underneath the. lower position of the pull gripper and thereby allow laundry articles to successively slide down underneath the pull gripper in pace with the pull gripper picking out laundry articles from the pile.

2. An apparatus according to claim 1, characterised in that the container is provided with wheels; and in that the means for positioning and lifting the container is constituted by a ramp located underneath the pull gripper and configured such that the wheels of the container can be driven onto the ramp, and wherein the ramp has a first end that is located relatively close to the lower position of the pull gripper, and a second end that is located relatively further away from the lower position of the pull gripper; and wherein at least one actuator is configured that is configured with a view to lifting the second end of the ramp relative to the first end of the ramp; and that the ramp comprises means for securing the container on the ramp.

3. An apparatus according to claim 3, characterised in that the ramp is, at its first end, provided with a gable that prevents the container from rolling off this end of the ramp; and in that the second end is configured with a chute that is configured such that it allows the container to be driven unimpeded onto the ramp.

4. An apparatus according to claim 1 or 2, characterised in that the ramp is, at its first end, turnably secured to the apparatus frame.

5. An apparatus according to any one of the preceding claims, characterised in that the apparatus is configured for lifting the bottom of the container upwards to an angle relative to the horizontal plane, which angle is between 30 and 60°.

6. An apparatus according to claim 5, characterised in that it comprises means for adjustment the angle of the bottom as desired relative to the horizontal plane, when the bottom is lifted.

7. An apparatus according to any one of the preceding claims, characterised in that means are configured with a view to shaking or vibrating the container in the position in which the one end of the container is lifted.

8. An apparatus according to claims 2 and 7, characterised in that the actuator is configured for being able to generate vibrations in the ramp and hence in the container.

9. An apparatus according to any one of the preceding claims, characterised in that it further comprises a lower conveyor located in such a manner that the one end of the conveyor extends underneath the lateral ledge that forms a slide face for the laundry articles when the one side of the container is lifted, and that the upper position of the pull gripper is located above the lower conveyor; and wherein the lower conveyor is configured with a view to transporting the laundry articles in a direction away from the container.

10. An apparatus according to claim 9, characterised in that, additionally, above the lower conveyor an upper conveyor is arranged that is also located underneath the upper position of the pull gripper and is configured for transporting the laundry articles in a direction away from the container.

11. A method for picking out, in an automated manner, laundry articles from a pile of laundry articles in a transportable container which is upwardly open and has a downwardly configured bottom, from where lateral ledges extend upwards to the container opening, and wherein the method comprises use of a pull gripper, said pull gripper being conveyed down into the container via the opening therein to a lower position, in which one or more laundry articles are seized by the pull gripper, and wherein the pull gripper is subsequently moved upwards to an upper position above the opening of the container, wherein the seized laundry articles are let go and drop onto a conveyor configured therefor that moves the laundry articles away from the container, and wherein the pile of laundry articles located in the container is successively moved in a direction towards the lower position of the pull gripper in pace, with laundry articles being picked out of the laundry pile in the container, characterised in that the laundry pile is moved by securing the container relative to the lower position of the pull gripper, and lifting the one side of the container in such a manner that the bottom of the container and at least one of the lateral ledges of the container form a pair of inclined lateral faces relative to the horizontal that converge to meet essentially vertically underneath the lower position of the pull gripper and thereby allow laundry articles from the container to successively slide underneath the pull gripper in pace with the pull gripper picking out laundry articles from the pile of laundry articles.

12. A method according to claim 11, characterised in that the container bottom is lifted to an angle relative to the horizontal, which angle is between 30 and 60 degrees.
